(19) United States
(12) Patent Application Publication
(10) Pub. No.: US 2005/0122045 A1
(43) Pub. Date: Jun. 9, 2005

(54) Plasma display panel

(76) Inventors: Wen-Fa Sung, Hsinchu City (TW); Yao-Ching Su, Taoyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/844,083

(22) Filed: May 12, 2004

(30) Foreign Application Priority Data
Dec. 5, 2003 (TW) 92134311

(51) Int. Cl. H01J 17/49

(52) U.S. Cl. 313/582; 313/585

(57) ABSTRACT

A plasma display panel. A first substrate is opposite a second substrate. A plurality of ribs are interposed between the first substrate and the second substrate, defining a plurality of discharge cells. A plurality of address electrodes are disposed on the second substrate, wherein each discharge cell is passed through a corresponding fence shaped address electrode. Each fence shaped address electrode comprises a plurality of main electrodes and at least one auxiliary electrode, and the auxiliary electrode connects two adjacent main electrodes in each cell.

### BACKGROUND OF THE INVENTION

1. Field of the Invention

The present invention relates to an AC plasma display panel and in particular to electrodes of an AC plasma display panel.

2. Description of the Related Art

A plasma display panel (PDP) is a thin type display, and typically has a large viewing area. The luminescent principle of the PDP is the same as that of fluorescent lamps. A vacuum glass trough is filled with inert gas. When a voltage is applied to the glass trough, plasma is generated and radiates ultraviolet (UV) rays. The fluorescent material coated on the wall of the glass trough absorbs the UV rays, hence the fluorescent material radiates visible light including red, green and blue light. A plasma display can be described as a combination of hundreds of thousands of illuminating units, each illuminating unit has three subunits for radiating red, green and blue light, respectively. Images are displayed by mixing these three primary colors.

As shown in FIG. 1, a conventional PDP 10 has a pair of glass substrates 12, and 14 arranged parallel and opposite to each other. A discharge space 16 is formed between the glass substrates 12, and 14 and injected with inert gases, such as Ar, Xe or others. The upper glass substrate 12 has a plurality of transverse electrode groups positioned in parallel. Each group of transverse electrodes has a first and a second sustaining electrode 18 and 20, each of which includes transparent electrodes 181 and 201 and bus electrodes 182 and 202. A dielectric layer 24 is further formed covering the transverse electrodes, and a protection layer 26 is formed on the dielectric layer 24.

The lower glass substrate 14 has a plurality of barrier ribs 28 arranged in parallel and spaced apart by a predetermined distance dividing the discharge space 16 into a plurality of groups of sub-discharge spaces. Each group of sub-discharge spaces includes a red discharge space 16R, a green discharge space 16G, and a blue discharge space 16B. Additionally, the lower glass substrate 14 has a plurality of lengthwise electrodes 22 disposed in parallel between two adjacent barrier ribs 28 serving as address electrodes. A red fluorescent layer 29R, a green fluorescent layer 29G, and a blue fluorescent layer 29B are respectively coated on the lower glass substrate 14 and the sidewalls of the barrier ribs 28 within each red discharge space 16R, each green discharge space 16G, and each blue discharge space 16B.

When a voltage is applied for driving the electrodes, the inert gases in the discharge space 16 are discharged to produce UV rays. The UV rays further illuminate the fluorescent layers 29R, 29G, and 29B to radiate visible light including red, green and blue light. After the three primary colors are mixed at different ratios, various images are formed and transmitted through the upper glass substrate 12.

FIG. 2 is a local top view of FIG. 1. Referring to FIG. 2, the ribs 28 are arranged in parallel and spaced apart from each other on the rear substrate. A discharge space 16 is disposed between the first sustain electrode 18 and the second sustain electrode 20. In the discharge space 16, the inert gas is ionized to strike the fluorescent layers on the rear substrate and the ribs 28 to generate light. If an address electrode 22 is broken at one point, the function of the address electrode is abnormal. In addition, line defects are generated and yield of the PDP is decreased.

U.S. Pat. No. 6,479,932 discloses an AC plasma display panel in which a data electrode having a large width part around the surface discharge gap and a narrow width part. The data electrode may further include a medium width part, however, the electrode of the configuration is prone to breakage.

### SUMMARY OF THE INVENTION

Accordingly, an object of the invention is to provide a PDP comprising fence shaped address electrodes. The fence shaped address electrodes of the invention are capable of remaining coupled even if one line of the fence shaped address electrodes is broken. Furthermore, due to the auxiliary electrode disposed at the discharge area of the cell, the PDP of the invention can provide larger plasma discharge area and better discharge efficiency.

To achieve the above objects, the present invention provides a PDP structure comprising the following elements. A first substrate is opposite a second substrate. A plurality of ribs are interposed between the first substrate and the second substrate, defining a plurality of discharge cells. A plurality of fence shaped address electrodes are disposed on the second substrate, wherein each discharge cell is passed through a corresponding fence shaped address electrode. Each fence shaped address electrode comprises a plurality of main electrodes and at least one auxiliary electrode, and the auxiliary electrode connects two adjacent main electrodes in each cell.

The plasma display panel of the invention additionally comprises a plurality a sub pixels, each comprising two row electrodes extending in a first direction and isolated from each other, and one fence shaped address electrode under and spaced apart from the row electrodes, extending substantially in a second direction. The fence shaped address electrode comprises a plurality of main electrodes and at least one auxiliary electrode connecting two adjacent main electrodes.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows the structure of the conventional PDP;

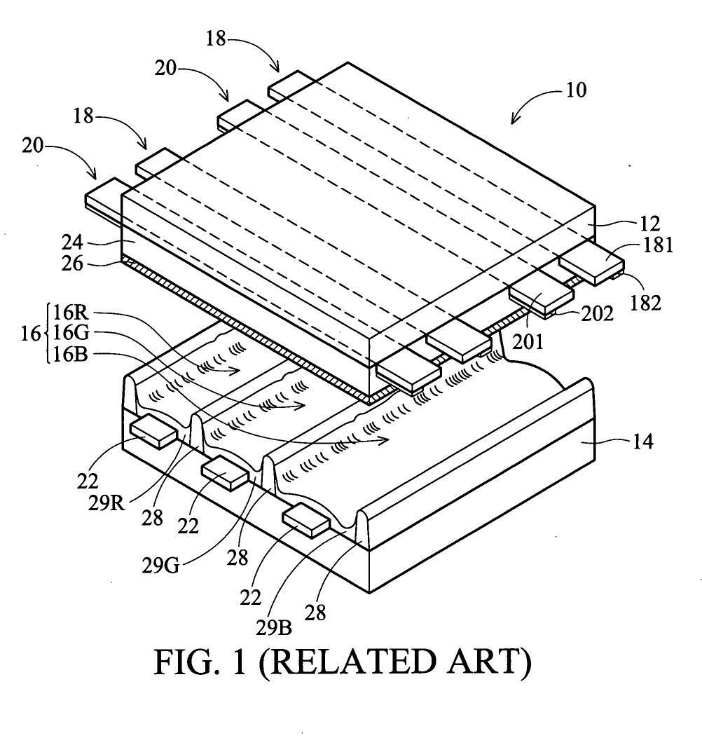

FIG. 2 is a plane view of the conventional PDP with closed discharge spaces;

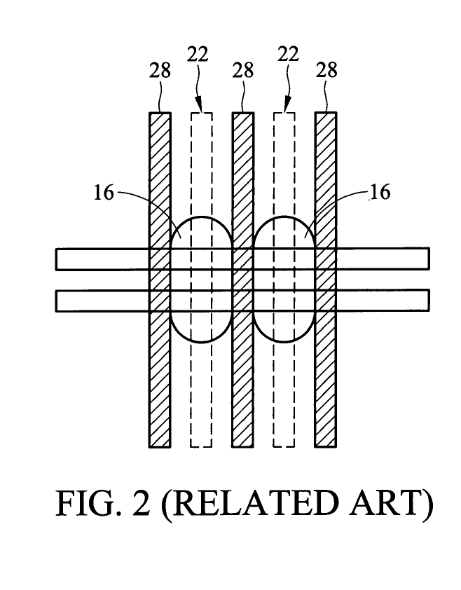

FIG. 3A is a top view of a PDP of the first embodiment;

FIG. 3B is a top view of a PDP of another electrode structure of the first embodiment;

FIG. 3C is a top view of a PDP of yet another electrode structure of the first embodiment;

FIG. 4 is a top view of a PDP of the second embodiment;

FIG. 5 is a top view of a PDP of the third embodiment;

FIG. 6 is a top view of a PDP of an electrode structure of the fourth embodiment;

FIG. 7 is a top view of a PDP of an electrode structure of the fifth embodiment;

FIG. 8 is a top view of a PDP of an electrode structure of the sixth embodiment.

### DETAILED DESCRIPTION OF THE INVENTION

The present invention provides a fence shaped address electrode passing through each discharge cell of a PDP, each comprising a plurality of main electrodes extending along direction Y and auxiliary electrodes connecting the main electrodes. Furthermore, a fence shaped address electrode in a cell and the one in another cell adjacent thereto along direction X are connected outside the display region of the PDP to form a common address electrode, and each common address electrode is not connected. The fence shaped address electrode of the invention is applicable in any rib and row electrode configuration. Structures of the ribs, row electrodes and fence shaped address electrodes are disclosed in detail in each of the followed embodiment.

### First Embodiment

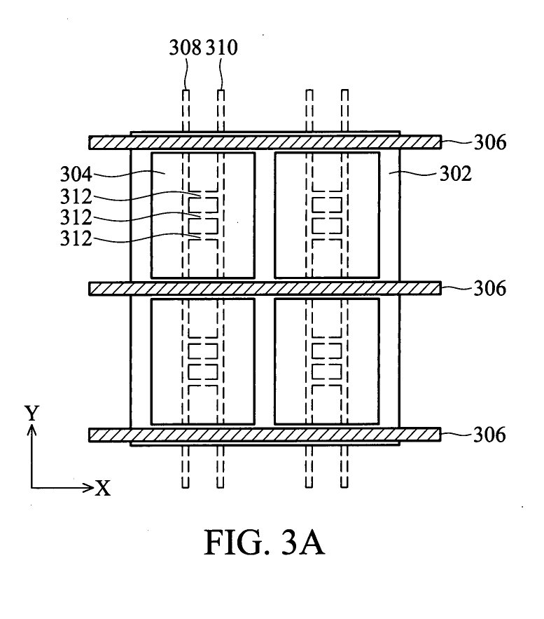

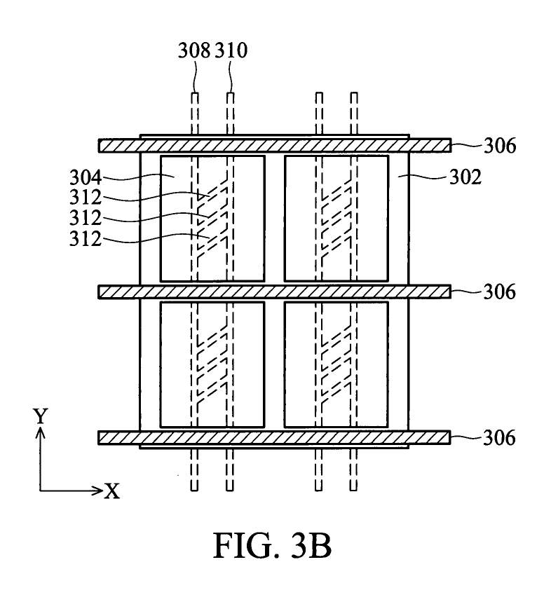

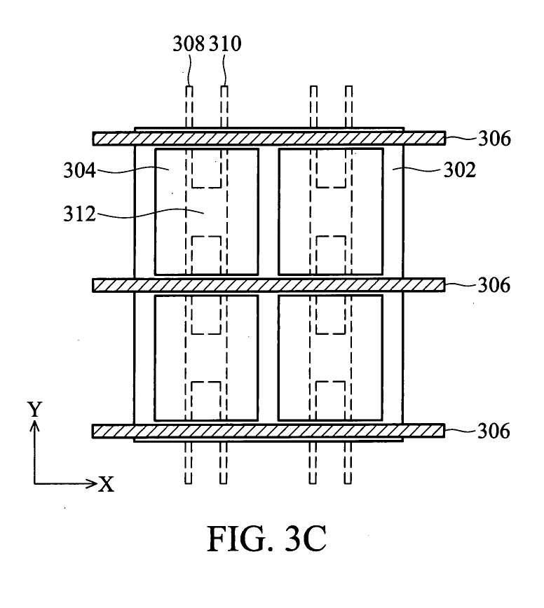

FIGS. 3A and 3B are top views of the PDP of the first embodiment. A PDP comprises a front substrate and a rear substrate. Referring to FIG. 3A, a plurality of ribs 302 are formed on the rear substrate, defining a plurality of closed rectangular discharge cells 304. The front and rear substrates are preferably glass.

A plurality of row electrodes 306 are formed on the front substrate, extending in the direction X along the horizontal side of the rectangular ribs 302. A plurality of fence shaped address electrodes are formed on the rear substrate, and each closed rectangular cell 304 passes trough a fence shaped address electrode, each of which comprises a plurality of main electrodes and at least one auxiliary electrode in each cell. In FIG. 3A, the main electrodes are referred to as a first main electrode 308 and a second main electrode 310. At least one auxiliary electrode 312 is interposed between the first main electrode 308 and the second main electrode 310, providing electrical connection therebetween. The auxiliary electrode 312 can be any shape and can electrically connect the main electrodes in any way. As shown in FIG. 3A, for example, the auxiliary electrodes 312 extend in the direction X, connecting the first and the second main electrodes 308 and 310. FIG. 3B shows another example, wherein the auxiliary electrodes 312 are tiled. In yet another example, as shown in FIG. 3C, the auxiliary electrode 312 has a predetermined width, preferably larger than 20 μm. Due to the auxiliary electrode 312 being disposed at the discharge area of the cell 304, the PDP of the invention can provide larger plasma discharge area and better discharge efficiency. In the preferred embodiment of the invention, each auxiliary electrode 312 is separated from the ribs 302 by a distance of 20 μm˜50 μm.

### Second Embodiment

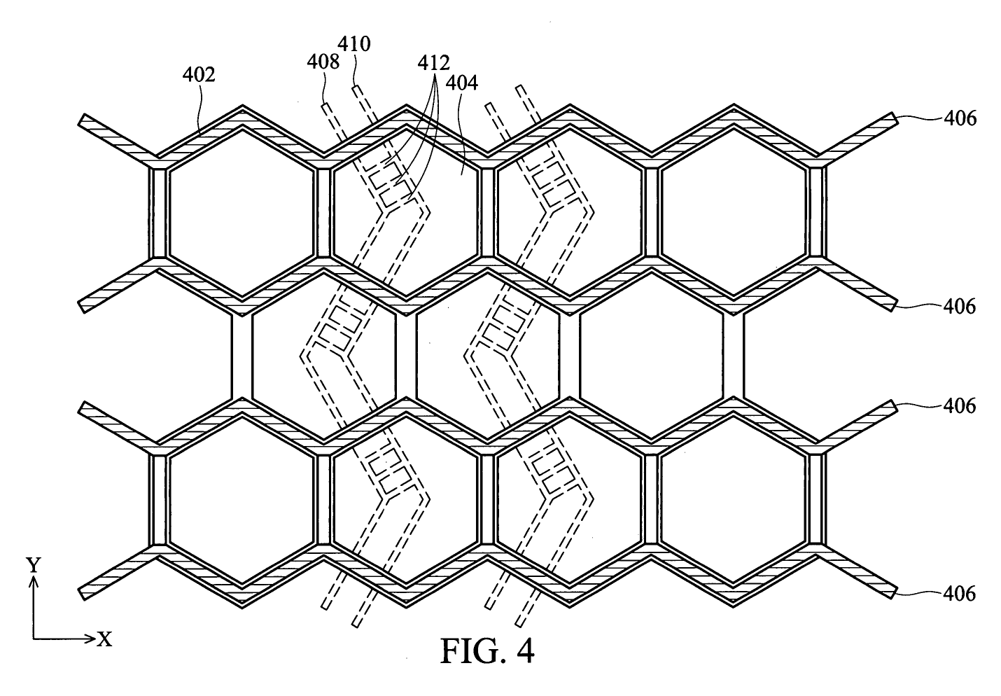

FIG. 4 is top view of the PDP of a second embodiment of the invention. A PDP comprises a front substrate and a rear substrate. Referring to FIG. 4, a plurality of ribs 402 are formed on the rear substrate, defining a plurality of closed hexagonal discharge cells 404. The front and rear substrates are preferably glass.

The hexagonal discharge cells 404 are arranged in delta configurations. A plurality of row electrodes 406 are formed on the front substrate, extending substantially in the direction X along the bevel side of the hexagonal ribs 402. A plurality of fence shaped address electrodes are formed on the rear substrate, and each closed hexagonal cell 404 pass trough a fence shaped address electrode, wherein each of which comprises a plurality of main electrodes and at least one auxiliary electrode. In FIG. 4, the main electrodes are referred to as a first main electrode 408 and a second main electrode 410, in which the first and second main electrodes are zigzag shaped and extend substantially in the direction Y.

At least one auxiliary electrode 412 is interposed between the first and the second main electrodes 408 and 410 in each cell, electrically connecting thereboth. The auxiliary electrode 412 can be any shape and can electrically connect the main electrodes in any way. Due to the auxiliary electrode 412 being disposed at the discharge area of the cell, the PDP of the invention can provide larger plasma discharge area and better discharge efficiency. In the preferred embodiment of the invention, each auxiliary electrode 412 is separated from the ribs 402 by a distance of 20 μm˜50 μm.

### Third Embodiment

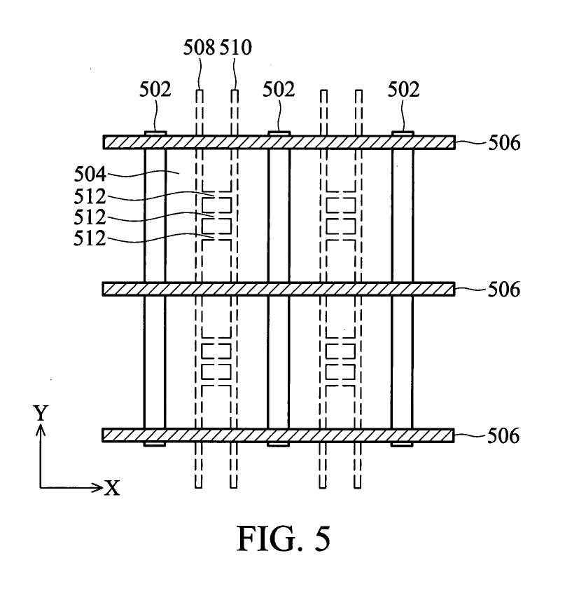

FIG. 5 is top view of the PDP of the third embodiment of the invention. A PDP comprises a front substrate and a rear substrate. Referring to FIG. 5, a plurality of line shaped ribs 502 are formed on the rear substrate, extending in the direction Y. The front and rear substrates are preferably glass.

A plurality of row electrodes 506 are formed on the front substrate, extending in the direction X. The line shaped ribs 502 and the row electrodes 506 define a plurality of discharge cells 504. A plurality of fence shaped address electrodes are formed on the rear substrate, and each rectangular cell passes trough a fence shaped address electrode, each of which comprises a plurality of main electrodes and at least one auxiliary electrodes. In FIG. 5, the main electrodes are referred to as a first main electrode 508 and a second main electrode 510. At least one auxiliary electrode 512 is interposed between the first and the second main electrode 508 and 510, providing electrical connection therebetween. The auxiliary electrode 512 can be any shape and electrically connects the main electrodes 508 and 510 in any way. Due to the auxiliary electrode 512 disposed at the discharge area of the cell, the PDP of the invention can provide larger plasma discharge area and better discharge efficiency. In the preferred embodiment of the invention, each auxiliary electrode 512 is separated from the ribs 502 by a distance of 20 μm˜50 μm.

### Fourth Embodiment

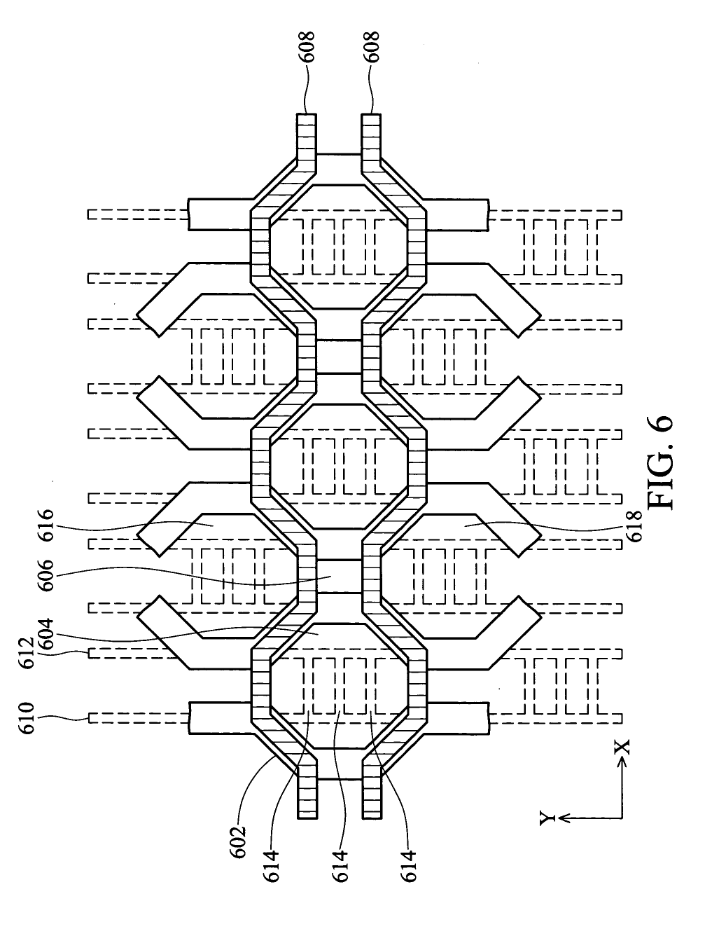

FIG. 6 is a top view of the PDP of a fourth embodiment of the invention. A PDP comprises a front substrate and a rear substrate. Referring to FIG. 6, a plurality of zigzag shaped ribs 602 are formed on the rear substrate, extending in the direction Y, defining a plurality of hexagonal discharge cells 604. A dark region 606 is interposed between each two adjacent discharge cells 616 and 618 along direction Y, connecting the two discharge cells. The front and rear substrates are preferably glass.

A plurality of row electrodes 608 are formed on the front substrate, extending substantially in the direction X along the bevel side of the hexagonal ribs 602. A plurality of fence shaped address electrodes are formed on the rear substrate, and each closed hexagonal cell passes trough a fence shaped address electrode, each of which comprises a plurality of main electrodes and at least one auxiliary electrode. In FIG. 6, the main electrodes are referred to as a first main electrode 610 and a second main electrode 612, in which the first and second main electrodes are zigzag shaped and extend substantially in the direction Y.

At least one auxiliary electrode 614 is interposed between the first main electrode 610 and the second main electrode 612 in each cell, providing electrical connection therebetween. The auxiliary electrode 614 can be any shape and electrically connects the main electrodes 610 and 612 in any way. Due to the auxiliary electrode 614 disposed at the discharge area of the cell the PDP of the invention can provide larger plasma discharge area and better discharge efficiency. In the preferred embodiment of the invention, each auxiliary electrode 614 is separated from the ribs 602 by a distance of 20 μm˜50 μm.

### Fifth Embodiment

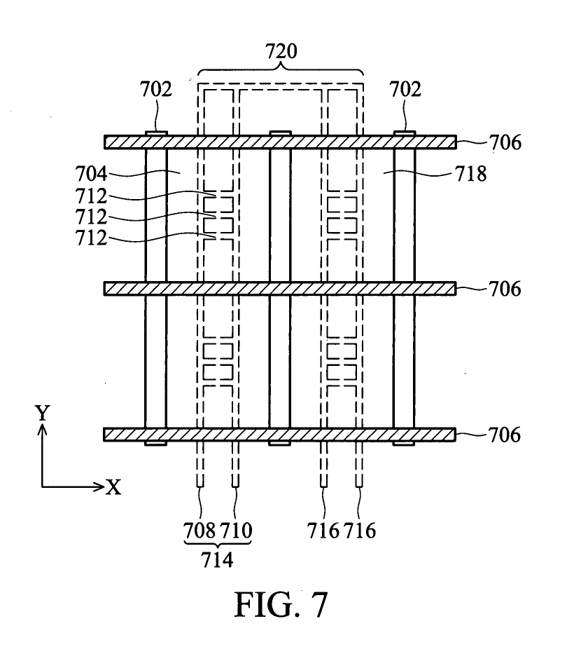

FIG. 7 is top view of the PDP of a fifth embodiment of the invention. A PDP comprises a front substrate and a rear substrate. Referring to FIG. 7, a plurality of line shaped ribs 706 are formed on the rear substrate, extending in the direction Y. The front and rear substrates are preferably glass.

A plurality of row electrodes 706 are formed on the front substrate, extending in the direction X. The line shaped ribs 702 and the row electrodes 706 define a plurality of discharge cells 704. A plurality of fence shaped address electrodes are formed on the rear substrate, and each rectangular cell passes trough a fence shaped address electrode, each of which comprises a plurality of main electrodes and at least one auxiliary electrode. In FIG. 7, the main electrodes are referred to as a first main electrode 708 and a second main electrode 710. At least one auxiliary electrode 712 is interposed between the first main electrode 708 and the second main electrode 710, providing electrical connection therebetween. The auxiliary electrode 712 can be any shape and electrically connect the main electrodes 708 and 710 in any way. Due to the auxiliary electrode 712 disposed at the discharge area of the cell, the PDP of the invention can provide larger plasma discharge area and better discharge efficiency. In the preferred embodiment of the invention, each auxiliary electrode 712 is separated from the ribs 702 by a distance of 20 μm˜50 μm.

A fence shaped address electrode 714 in a cell and the one 716 in another cell 718 adjacent thereto along direction X are connected outside the PDP's display region to form a common address electrode 720, and each common address electrode 720 is not connected.

### Sixth Embodiment

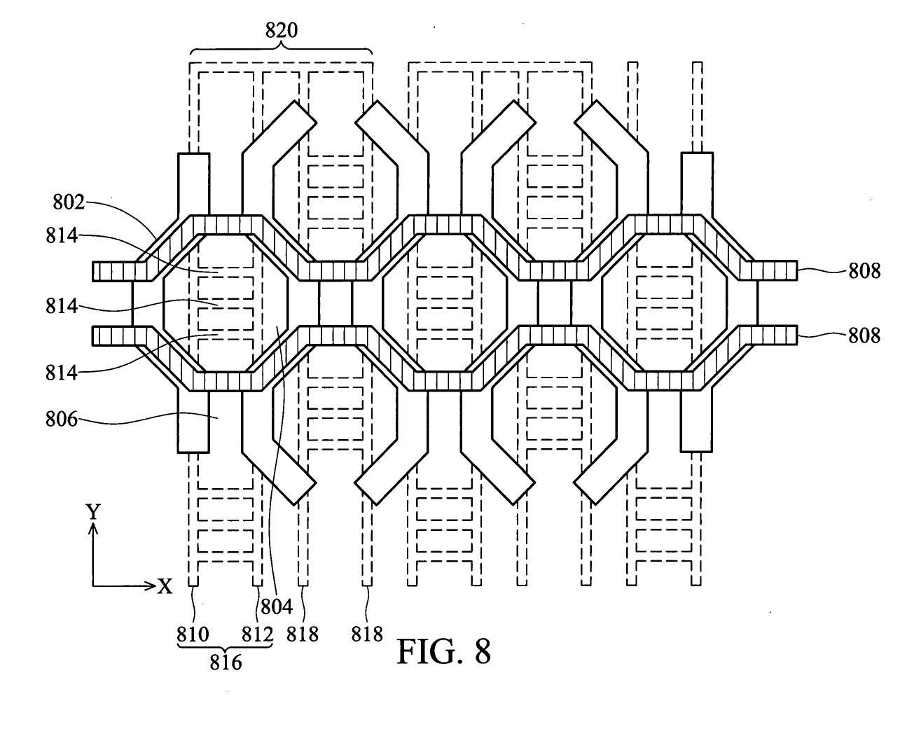

FIG. 8 is a top view of the PDP of the sixth embodiment. A PDP comprises a front substrate and a rear substrate. Referring to FIG. 8, a plurality of zigzag shaped ribs 802 are formed on the rear substrate, extending in the direction Y, defining a plurality of hexagonal discharge cells 804. A dark region 806 is interposed between each two adjacent discharge cells along direction Y, connecting the two discharge cells. The front and rear substrates are preferably glass.

A plurality of row electrodes 808 are formed on the front substrate, extending substantially in the direction X along the bevel side of the hexagonal ribs. A plurality of fence shaped address electrodes are formed on the rear substrate, and each closed hexagonal cell passes trough a fence shaped address electrode, each of which comprises a plurality of main electrodes and at least one auxiliary electrodes. In FIG. 8, the main electrodes are referred to as a first main electrode 810 and a second main electrode 812, in which the first and second main electrodes are zigzag shaped extending substantially in the direction Y.

At least one auxiliary electrode 814 is interposed between the first and the second main electrodes 810 and 812 in each cell, providing electrical connection therebetween. The auxiliary electrode 814 can be any shape and electrically connects the main electrodes in any way. Due to the auxiliary electrode 814 being disposed at the discharge area of the cell, the PDP of the invention can provide larger plasma discharge area and better discharge efficiency. In the preferred embodiment of the invention, each auxiliary electrode 814 is separated from the ribs by a distance of 20 μm˜50 μm.

A fence shaped address electrode 816 and the neighboring one 818 along direction X are connected outside the display region of the PDP to form a common address electrode 820, and each common address electrode 820 is not connected.

The above described common address electrode is applied in the rib and electrode structures of the fifth and the sixth embodiments. The described common address electrodes can be further applied in the rib structures and row address structures disclosed in the first, second, third and fourth embodiment.

The fence shaped address electrodes of the invention can remain coupled even if one electrode of the fence shaped address electrodes is broken. Furthermore, Due to the auxiliary electrode being disposed at the discharge area of the cell, the PDP of the invention can provide larger plasma discharge area and better discharge efficiency.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of thee appended claims should be accorded the broadest interpretation so as to encompass all such modifications and similar arrangements.

1. A structure of a plasma display panel, comprising:
a first substrate and a second substrate;
a plurality of ribs interposed between the first substrate and the second substrate, defining a plurality of discharge cells; and
a plurality of address electrodes disposed on the second substrate, wherein each discharge cell is passed through a corresponding address electrode, each address electrode comprises a plurality of main electrodes and at least one auxiliary electrode, and the auxiliary electrode connects two adjacent main electrodes in each cell.

2. The structure as claimed in claim 1, wherein the auxiliary electrode is separated from the ribs by a distance of 20 μm˜50 μm.

3. The structure as claimed in claim 1, wherein the auxiliary electrode is perpendicular to the main electrodes.

4. The structure as claimed in claim 1, wherein auxiliary electrode has a predetermined width larger than 20 μm.

5. The structure as claimed in claim 1, wherein the discharge cells are closed, each comprising a first portion along a first direction and a second portion along a second direction, and the first direction and the second direction are perpendicular.

6. The structure as claimed in claim 1, wherein the main electrodes are line shaped or zigzag shaped.

7. The structure as claimed in claim 5, further comprising a plurality of row electrodes, each extending along the first portion of the rib.

8. The structure as claimed in claim 5, wherein the discharge cells are hexagonal and arranged in the second direction, a dark region is interposed between two adjacent discharge cells for connection thereof along the second direction.

9. The structure as claimed in claim 5, wherein each address electrode is connected with the adjacent one along the first direction outside a display region of the plasma display panel to form a common address electrode, and each common address electrode is not connected.

10. A plasma display panel, comprising a plurality a sub pixels, each comprising:
two row electrodes extending in a first direction and isolated from each other; and
one address electrode under and spaced apart from the row electrodes, extending substantially in a second direction, wherein the address electrode comprises a plurality of main electrodes and at least one auxiliary electrode connecting two adjacent main electrodes.

11. The plasma display panel as claimed in claim 10, wherein the auxiliary electrode is perpendicular to the main electrodes.

12. The plasma display panel as claimed in claim 10, wherein auxiliary electrode has a predetermined width larger than 20 μm.

13. The plasma display panel as claimed in claim 10, wherein the sub pixel is rectangular or hexagonal.

14. The plasma display panel as claimed in claim 10, wherein the first direction and second direction are perpendicular.
